(19) United States
(12) Patent Application Publication
(10) Pub. No.: US 2022/0005165 A1
(43) Pub. Date: Jan. 6, 2022

(54) IMAGE ENHANCEMENT METHOD AND APPARATUS

(71) Applicant: BOE TECHNOLOGY GROUP CO., LTD., Beijing (CN)

(72) Inventors: Dan Zhu, Beijing (CN); Pablo Navarrete Michelini, Beijing (CN)

(73) Assignee: BOE TECHNOLOGY GROUP CO., LTD., Beijing (CN)

(21) Appl. No.: 16/495,550

(22) PCT Filed: May 6, 2019
(86) PCT No.: PCT/CN2019/085711

§ 371 Date: Sep. 19, 2019

(30) Foreign Application Priority Data
Jun. 28, 2018 (CN) 201810686408.7

(51) Int. Cl. G06T 5/00

(52) U.S. Cl. CPC G06T 5/009; G06T 2207/20081; G06T 2207/10024

(57) ABSTRACT

The present disclosure relates to an image enhancement method. The image enhancement method may include acquiring an input image; solving an incident component of the input image that minimizes a loss function; and obtaining an optimized image of the input image based on the incident component, wherein the loss function comprises an activation function.

### CROSS-REFERENCE TO RELATED APPLICATIONS

This application claims benefit of the filing date of Chinese Patent Application No. 201810686408.7 filed on Jun. 28, 2018, the disclosure of which is hereby incorporated in its entirety by reference.

### TECHNICAL FIELD

The present disclosure relates to the field of image processing, and in particular, to an image enhancement method and an apparatus.

### BACKGROUND

Images are important carriers for humans to acquire and transmit information. Images are needed in many scenarios such as daily life, public security criminal investigation, biomedical science, or animated games. However, the process of acquiring images is inevitably affected by the illumination conditions, thereby resulting in color shift phenomenon and accordingly poor image quality.

### BRIEF SUMMARY

An embodiment of the present disclosure provides an image enhancement method. The image enhancement method may include acquiring an input image; solving an incident component of the input image that minimizes a loss function; and obtaining an optimized image of the input image based on the incident component, wherein the loss function comprises an activation function.

Optionally, the loss function is the following function:

F=c₁∥∇l∥₂²+c₂∥l−s∥₂²+c₃∥∇(s−l)∥ₗ+Relu(s−l)

wherein, c₁, c₂ and c₃ are preset weight values, l is a logarithm of the incident component, s is a logarithm of the input image, and ∇l is the first-order partial derivative of l, ∇(s−l) is the first-order partial derivative of s−l.

Optionally, the loss function is the following function:

F=c₁∥e^{l}∇l∥₂²+c₂∥l−s∥₂²+c₃∥e^{(s-l)}∇(s−l)∥ₗ+Relu(s−l)

wherein, c₁, c₂ and c₃ are preset weight values, l is a logarithm of the incident component, s is a logarithm of the input image, and ∇l is the first-order partial derivative of l, ∇(s−l) is the first-order partial derivative of s−l.

Optionally, ∇l and ∇(s−l) are solved with Scharr operator.

Optionally, solving the incident component of the input image that minimizes the loss function comprises solving the incident component of the input image that minimizes the loss function using an Adam optimization algorithm.

Optionally, obtaining the optimized image of the input image based on the incident component comprises removing the incident component in the input image to obtain a reflected component of the input image; performing gamma correction on the incident component to obtain a corrected component; and obtaining a product of the reflected component and the corrected component as the optimized image.

Optionally, the image enhancement method according to some embodiments of the present disclosure, before obtaining the optimized image of the input image based on the incident component, further comprises acquiring image information of a H channel, image information of a S channel, image information of a V channel in a hue, saturation value HSV space of the input image, the incident component being an incident component of the image information of the V channel.

Optionally, obtaining the optimized image of the input image based on the incident component comprises obtaining image information of an optimized V channel of the input image based on the incident component and converting the image information of the H channel, the image information of the S channel, and the image information of the optimized 24 V channel into the optimized image of the red, green and blue RGB space.

One embodiment of the present disclosure is an image enhancement apparatus. The image enhancement apparatus may include a first acquiring circuit configured to acquire an input image; a solving circuit configured to solve an incident component of the input image that minimizes a loss function; a processing circuit configured to obtain an optimized image of the input image based on the incident component, wherein the loss function comprises an activation function.

Optionally, the loss function is the following function:

F=c₁∥∇l∥₂²+c₂∥l−s∥₂²+c₃∥∇(s−l)∥ₗ+Relu(s−l)

wherein, c₁, c₂ and c₃ are preset weight values, l is a logarithm of the incident component, s is a logarithm of the input image, and ∇l is the first-order partial derivative of l, ∇(s−l) is the first-order partial derivative of s−l.

Optionally, the loss function is the following function:

F=c₁∥e^{l}∇l∥₂²+c₂∥l−s∥₂²+c₃∥e^{(s-l)}∇(s−l)∥ₗ+Relu(s−l).

wherein, c₁, c₂ and c₃ are preset weight values, l is a logarithm of the incident component, s is a logarithm of the input image, and ∇l is the first-order partial derivative of l, ∇(s−l) is the first-order partial derivative of s−l.

Optionally, ∇l and ∇(s−l) are solved with Scharr operator.

Optionally, the solving circuit is configured to solve the incident component of the input image that minimizes the loss function using an Adam optimization algorithm.

Optionally, the processing circuit comprises a removing sub-circuit, configured to remove the incident component in the input image to obtain a reflected component of the input image; a correcting sub-circuit, configured to perform gamma correction on the incident component to obtain a corrected component; and an operating sub-circuit, configured to obtain a product of the reflected component and the corrected component as the optimized image.

Optionally, the image enhancement apparatus according to some embodiments of the present disclosure further comprises a second acquiring circuit, configured to acquire image information of an H channel, image information of the S channel, and image information of the V channel in a HSV space of the input image, wherein the incident component is an incident component of image information of the V channel.

Optionally, the processing circuit comprises a processing sub-circuit, configured to obtain image information of an optimized V channel of the input image based on the incident component; and a converting sub-circuit, configured to convert the image information of the H channel, the image information of the S channel, and the image information of the optimized V channel into the optimized image of a red, green, and blue RGB space.

One example of the present disclosure is an electronic apparatus, comprising: a memory, a processor, and a computer program stored on the memory and operable on the processor, the computer program configured to be executed by the processor to implement the image enhancement method according to some embodiments of the present disclosure.

One example of the present disclosure is a computer readable storage medium, wherein the computer readable storage medium stores a computer program, the computer program configured to be executed by a processor to implement the image enhancement method according to some embodiments of the present disclosure.

### BRIEF DESCRIPTION OF THE DRAWINGS

The subject matter which is regarded as the disclosure is particularly pointed out and distinctly claimed in the claims at the conclusion of the specification. The foregoing and other objects, features, and advantages of the present disclosure are apparent from the following detailed description taken in conjunction with the accompanying drawings in which:

FIG. 1 is a schematic diagram of a Retinex theory provided by one embodiment of the present disclosure;

FIG. 2 is a flowchart of an image enhancement method based on Retinex theory according to one embodiment of the present disclosure;

FIG. 3 is a schematic diagram of an optimization solution provided by one embodiment of the present disclosure;

FIG. 4 is a schematic diagram of an image enhancement method based on Retinex theory according to one embodiment of the present disclosure;

FIG. 5 is a structural diagram of an image enhancement apparatus based on Retinex theory according to one embodiment of the present disclosure;

FIG. 6 is a structural diagram of an image enhancement apparatus based on Retinex theory according to one embodiment of the present disclosure;

FIG. 7 is a structural diagram of an image enhancement apparatus based on Retinex theory according to one embodiment of the present disclosure; and

FIG. 8 is a structural diagram of an electronic apparatus according to one embodiment of the present disclosure.

### DETAILED DESCRIPTION

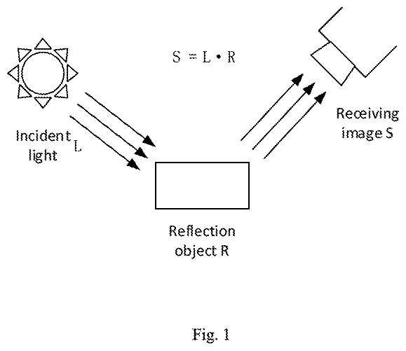

The present disclosure will be described in further detail with reference to the accompanying drawings and embodiments in order to provide a better understanding by those skilled in the art of the technical solutions of the present disclosure. Throughout the description of the disclosure, reference is made to FIGS. 1-8. When referring to the figures, like structures and elements shown throughout are indicated with like reference numerals.

Unless otherwise defined, any technical or scientific term used herein shall have the common meaning understood by a person of ordinary skill in the art. Words such as “first” and “second” used in the specification and claims are merely used to differentiate different components rather than to represent any order, number or importance of the components. Similarly, such word as “including” or “comprising” are merely used to represent that the element or unit presented prior to the word contains elements, units and the like enumerated subsequent to the word, instead of excluding other elements or units.

In the embodiments of the present disclosure, for the sake of easy understanding and description, the functional circuits and functional sub-circuits are described with correspondence to the functions to be performed. It is easy to understand that these circuits and sub-circuits are functional entities, and do not necessarily have to correspond to physically or logically independent entities. These functional entities may be implemented in the form of computer instructions executed by a general purpose processor running corresponding functional software, or programmably implemented in one or more hardware modules or integrated circuits, or implemented by an integrated circuit designed to perform the corresponding functions. For example, a general purpose processor may be a central processing unit (CPU), a single chip microcomputer (MCU), a digital signal processor (DSP), or the like. The programmable integrated circuit may be a field programmable logic circuit (FPGA). A specialized integrated circuit may be an application specific integrated circuit (ASIC). A specialized integrated circuit may also be constructed by a number of basic electrical components such as transistors, resistors, capacitors, inductors, etc., according to desired functions.

The technical problems, the technical solutions, and the advantages of the present disclosure will be more clearly described in the following description.

The image enhancement method according to some embodiments of the present disclosure can be applied in at least two scenarios. The first scenario is photographing at night, for example, using a mobile phone. The image enhancement method according to some embodiments of the present disclosure can provide advantages such as enhanced brightness of the image and improved quality of the low-exposure image. As such, the image taken at night is still clearly visible. The second scenario relates to auxiliary driving. When a driver is driving at night, the image enhancement method according to some embodiments of the present disclosure can be used to enhance the brightness of the image taken by the driving recorder to ensure safe driving of the driver.

FIG. 1 is a schematic diagram of a Retinex theory according to one embodiment of the present disclosure. As shown in FIG. 1, in Retinex theory, the image is mainly composed of two components, the incident component and the reflected component, as shown below:

S=L×R

Where L is the incident component, R is the reflected component, and S is the image formed by the observer or camera. Among them, the incident component L determines the dynamic range that a pixel can reach in an image, and the reflected component R determines the intrinsic property of the image. As shown in FIG. 1, the purpose of Retinex theory is to discard or remove the nature of the incident component from the image S, thereby obtaining the original image, and thus achieving image enhancement.

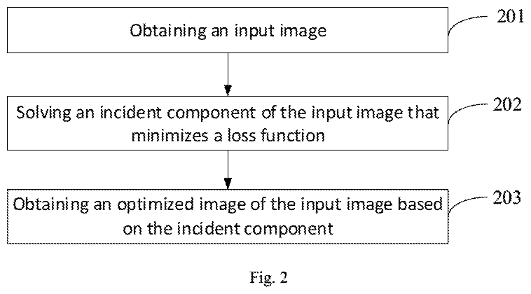

FIG. 2 is a flowchart of an image enhancement method based on Retinex theory according to one embodiment of the present disclosure. As shown in FIG. 2, the image enhancement method includes the following steps:

Step 201 includes acquiring an input image.

Step 202 includes solving an incident component of the input image that minimizes a loss function.

Step 203 includes obtaining an optimized image of the input image based on the incident component.

Wherein, the loss function comprises an activation function.

The above input image may be an image acquired by an image acquisition apparatus, for example, an image captured by a camera of a mobile phone, a camera, or the like. Furthermore, the above input image may be a still image or a moving image such as a video.

The above loss function may be pro-configured, for example, received from other apparatus, or configured by a user, or obtained by pre-optimization.

In some embodiments, solving the incident component of the input image that minimizes the loss function may include solving the minimum of the loss function by an optimization algorithm to obtain an incident component of the above input image. For example: it includes initializing l (l is the logarithm of the incident component) in the above loss function, and then continuously optimizing I in the loss function by the optimization algorithm until the minimum value of the loss function is solved, and and l at this time is taken as the logarithm of the incident component of the input image, thereby obtaining the incident component of the input image.

It should be noted that the minimum loss function may mean that the loss function satisfies a specific condition. For example, when the value of the loss function is smaller than a target threshold, it is determined that the loss function is minimum at this time. Wherein, the above target threshold may be a threshold determined according to a theoretical minimum value (for example: 0), such as 0.001, 0.0001 or 0.002, etc. Preferably, the above target threshold may be set according to a theoretical minimum value in combination with the actual situation of image enhancement.

The above-mentioned loss function includes an activation function for ensuring the above-mentioned loss function. For example, the activation function is used to ensure that the constraint condition includes L≥S or l≥s, where L is the incident component, S is the input image, l is the logarithm of the incident component, and s is the logarithm of the input image.

In some embodiments, obtaining an optimized image of the input image based on the incident component is based on Retinex theory. Because S=L×R in Retinex theory, and when the incident component is determined, an optimized image of the input image can be obtained.

In the above steps, due to the activation function included in the loss function, in the image enhancement process, it is not necessary to separately determine the constraint conditions, thereby improving the computational efficiency in the image enhancement process.

It should be noted that, in the embodiments of the present disclosure, based on S=L×R in the Retinex theory, in order to simplify the operation, the multiplication relationship can be converted into addition in the log domain, that is:

s=log S(x,y), l=log L(x,y), r=log R(x,y)

Then: s=l+r, wherein x and y are the coordinates of the pixel points in the input image. The base of the logarithm may be other values such as e, 2, 10, etc., which are not limited thereto.

In the embodiment of the present disclosure, it is assumed that the incident component and the reflected component satisfy the following assumptions:

1. Assuming that the incident component is sufficiently uniform in space;

2. The value of the reflected component R is limited to 0 to 1. Thus, L≥S. Moreover, since the base of the logarithm in the embodiment of the present disclosure is a value greater than 1, the logarithmic domain is monotonically increasing. Thus, l≥s.

3. Assuming that the incident component is a constant C, and C is greater than any point in S, then C is a trivial solution that satisfies the above two assumptions. Thus, it can be assumed that L is infinitely closer to S but greater than S; and

4. Assuming that r=s−l has a higher priori probability.

In this way, according to the above four assumptions, the following penalty function can be obtained by integrating the four assumptions into an expression:

F=c₁∥∇l∥₂²+c₂∥l−s∥₂²+c₃∥∇(s−l)∥ₗ

Wherein c₁, c₂, c₃ are their respective weight values, which may be pre-configured. For example, it can be set according to experience or needs, and l≥s. It should be noted that, in the embodiment of the present disclosure, the loss function may also be referred to as a penalty function.

Furthermore, because ∇(log(L))=1/L∇L, when L is very small, the log(L) derivative depends heavily on 1/L.

In order to solve this problem, the penalty function can be modified as follows:

F=c₁∥e^{l}∇l∥₂²+c₂∥l−s∥₂²+c₃∥e^{(s-l)}∇(s−l)∥ₗ, Satisfying l≥s

As shown from the above formula, the first term in the formula c₁∥∇l∥₂² is modified as c₁∥e^{j}∇l∥₂², that is, further multiplying the coefficient e^{l}, and the role of the original formula is not changed. Assuming l=log(L), and the base is e, then e^{l}=L, that is c₁∥e^{l}∇l∥₂²=c₁∥L∇l∥₂², and when

$$∇ l = ∇ ( log ( L ) ) = \frac{1}{L} ∇ L$$

is brought in it to obtain the following:

$${c}_{1} {‖ {e}^{l} ∇ l ‖}_{2}^{2} = {c}_{1} {‖ L ∇ l ‖}_{2}^{2} = {c}_{1} {‖ L \frac{1}{L} ∇ L ‖}_{2}^{2} = {c}_{1} {‖ ∇ L ‖}_{2}^{2} .$$

As such, the first term is only related to ∇L, thereby eliminating the impact of 1/L. Similarly, the third term in the above penalty function can be obtained. Thus, the quality of the image can be improved through the above formula even when L is very small.

In some embodiments, the above loss function contains an activation function, and the activation function can use the Relu activation function. The Relu activation function is an activation function of deep learning, defined as: Relu(x)=max(0,x). As such, through the above penalty function, that Relu(s−l) is 0 is used to ensure l. Thus, in one embodiment, the above loss function is the following function:

F=c₁∥e^{l}∇l∥₂²+c₂∥l−s∥₂²+c₃∥e^{(s-l)}∇(s−l)∥ₗ+Relu(s−l)

Wherein, c₁, c₂ and c₃ are weight values, l is the logarithm of the incident component, s is the logarithm of the input image, and ∇l is the first-order partial derivative of l, ∇(s−l) is the first-order partial derivative of s−l.

The above first term ∥e^{l}∇l∥₂² represents that the incident component space is sufficiently smooth, the second term ∥l−s∥₂² represents the incident component infinitely close to and larger than the captured image, and the third term ∥e^{(s-l)}∇(s−l)∥ₗ indicates that the reflected component has a large priori probability. Furthermore, the Relu activation function implements the fusion of the constraint l≥s as part of the loss function, and is no longer a separate constraint for solving the loss function.

In some embodiments, the first-order partial derivative of the image can be calculated by using a first-order differential operator. Preferably, the Scharr operator is used to solve ∇l and ∇(s−l). Specifically, the Scharr operator can be defined as follows:

$${G}_{x} = [ \begin{matrix}3 & 0 & - 3 \\ 10 & 0 & - 10 \\ 3 & 0 & - 3\end{matrix} ] , {G}_{y} = [ \begin{matrix}3 & 0 & 3 \\ 0 & 0 & 0 \\ - 3 & - 10 & - 3\end{matrix} ]$$

In this way, the derivative of image A is solved: ∇A=\sqrt{(Gₓ×A)²+(G_{y}×A)²}, so as to obtain ∇l=\sqrt{(Gₓ×l)²+(G_{y}×l)²}, ∇(s−l)={square root over ((Gₓ×(s−l))²+(G_{y}×(s−l))²+(G_{y}×(s−l))²)}.

Of course, in the embodiments of the present disclosure, the above operator elements 0, 3, −3, 10, and −10 are not limited. For example: the operator elements can be replaced with other constants, such as 0, 4, −4, 10, −10, etc.

In this way, the Scharr operator is used to solve the problem, so that the zero gradient in backpropagation can be avoided. This is beneficial to the spatial smoothing of the incident component, thereby improving the quality of the optimized image.

By the difference in the loss function described above, the processing efficiency can be improved, the memory consumption can be reduced, and the quality of the optimized image can be improved. For example, the above loss function can effectively improve the quality of pictures taken at night, make the picture content clearer, effectively improve image detail blurring, and improve image contrast, distortion color recovery, and gain compensation, etc.

In some embodiments, the loss function is not limited to the function represented by the above formula. For example, in some scenarios, the above loss function can also be the following function:

F=c₁∥∇l∥₂²+c₂∥l−s∥₂²+c₃∥∇(s−l)∥ₗ+Relu(s−l)

The above loss function is used without considering that when L is very small, the derivative of log(L) is very dependent on 1/L. As such, the quality of the optimized image is worse than that of the optimized image obtained by using this loss function F=c₁∥e^{l}∇l∥₂²+c₂∥l−s∥₂²+c₃∥e^{(s-l)}∇(s−l)∥ₗ+Relu(s−l). But the above loss function can also improve the operational efficiency of the image enhancement process. Alternatively, F=c₁∥e^{l}∇l∥₂²+c₂∥l−s∥₂²+c₃∥e^{(s-l)}∇(s−l)∥ₗ+Relu(s−l) can be considered to further limit F=c₁∥∇l∥₂²+c₂∥l−s∥₂²+c₃∥∇(s−l)∥ₗ+Relu(s−l).

In one embodiment, solving an incident component of the input image that minimizes a loss function includes solving the minimum of the loss function using an Adam optimization algorithm to obtain the incident component of the input image.

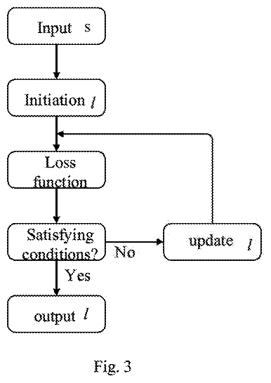

For example, as shown in FIG. 3, Input s, and initialize l, and calculate the above loss function to determine whether the loss function satisfies the condition (ie, determine whether the loss function is minimum). If not, update l and calculate the above loss function again to determine whether the loss function satisfies the condition until the loss function satisfies the condition (i.e., the loss function is judged to be the smallest), Then, output l. The above updating of l is continuously optimized through the Adam optimization algorithm.

In some embodiments, l can be used as the parameter to be optimized, and the Adam optimization algorithm is used to continuously optimize 1, so that the loss function is minimized, and the optimal solution of l is obtained. Then, the exponential solution for l can be solved to obtain L=e^{l}. The optimized image can then be obtained by the reflected component R=S/L. The usage of Adam optimization algorithm can improve the computational efficiency of the algorithm, reduce the memory loss, and is easy to implement.

The Adam optimization algorithm is illustrated through the example below:

Adam is a first-order optimization algorithm that can replace the traditional stochastic gradient descent process. It uses the first-order moment estimation and second-order moment estimation of the gradient to dynamically adjust the learning rate of each parameter. Among them, Adam's advantage is mainly that after the offset correction, each iterated learning rate has a certain range, thereby making the parameters relatively stable. The formula can be as follows:

$${m}_{t} = μ * {m}_{t - 1} + ( 1 - μ ) * {g}_{t}$$

$${n}_{t} = v * {n}_{t - 1} + ( 1 - v ) * {g}_{t}^{2}$$

$${\hat{m}}_{t} = \frac{{m}_{t}}{1 - {μ}^{′}}$$

$${\hat{n}}_{t} = \frac{{n}_{t}}{1 - {v}^{′}}$$

$$Δ {θ}_{t} = - \frac{{\hat{m}}_{t}}{\sqrt{{\hat{n}}_{t} + ɛ}} * η$$

Wherein η is the learning rate, t is the number of iterations, gₜ is the gradient of the image, and mₜ and nₜ are the first-order moment estimation and the second-order moment estimation of the gradient, respectively, which can be regarded as an estimate of the expectation E[gₜ] and E[gₜ²]. \hat{m}ₜ and \hat{n}ₜ are corrections to mₜ and nₜ, so that they can be approximated as unbiased estimates of expectations, Parameter μ and parameter v can be manually set, and are used to estimate \hat{m}ₜ and \hat{n}ₜ. In general, μ=0.9, v=0.99 or other values.

In this way, Adam can directly estimate the moment of the gradient without additional requirements on the memory, and can dynamically adjust according to the gradient. Furthermore,

$$- \frac{{\hat{m}}_{t}}{\sqrt{{\hat{n}}_{t} + ɛ}}$$

form a dynamic constraint on the learning rate, and have a clear scope. ε is the error to ensure that the denominator is not zero, and the general value is ε=le−8.

In the optimization process, the above gₜ is the gradient of the current image. Here, the current image referred to is actually the incident component obtained by the current iteration, that is, gₜ is the gradient of the incident component l, and that is, gₜ=∇l.

Through the above description, it can be concluded that the Adam algorithm has the following advantages: efficient calculation, less memory required, invariance of gradient diagonal scaling, suitable for solving optimization problems with large-scale data and parameters, for non-steady-state targets, and for solving problems with very high noise or sparse gradients. Furthermore, the super parameters can be explained intuitively, and basically only a very small amount of tuning is required.

It should be noted that the foregoing formulas are only used to exemplify the Adam optimization algorithm. In the embodiments of the present disclosure, the Adam optimization algorithm is not limited herein.

In some embodiments, obtaining an optimized image of the input image based on the incident component includes removing the incident component in the input image to obtain a reflected component of the input image; performing gamma correction on the incident component to obtain a corrected component; and obtaining the product of the reflected component and the corrected component as the optimized image.

In some embodiments, removing the incident component in the input image to obtain a reflected component of the input image may be obtained based on the formula S=L×R in Retinex theory. S represents the input image, L represents the incident component, and R represents the reflected component.

The gamma correction of the incident component may be performed by editing a gamma curve of an incident component to perform nonlinear tone editing on the incident component, thereby obtaining the above corrected component. Of course, the gamma correction of the incident component described above can also be performed by the following formula for gamma correction:

$${L}^{′} = {W ( \frac{L}{W} )}^{\frac{1}{γ}}$$

Where L′ is the corrected component, W=2^{b}−1, b is the number of bits of the image. For example, for a 8-bit image, W=255.

After obtaining the corrected component by the above gamma correction, the above optimized image S′ can be obtained through the formula S′=L′×R.

In this embodiment, an optimized image is obtained based on the connected component, so that the image can be appropriately adjusted based on the incident component including the illumination information to generate a visual effect of the dark image. As such, the obtained image is closer to the real image, thereby improving the image quality.

In some embodiments, before obtaining an optimized image of the input image based on the incident component, the method further includes obtaining image information of the H channel, image information of the S channel, and image information of the V channel in the Hue Saturation Value (HSV) space of the input image, wherein the incident component is an incident component of image information of the V channel.

In one embodiment, obtaining an optimized image of the input image based on the incident component includes obtaining image information of the optimized V channel of the input image based on the incident component and converting image information of the H channel, image information of the S channel, and image information of the optimized V channel into the optimized image of a Red Green Blue (RGB) space.

Wherein, the image information of the H channel represents the hue of the image, the image information of the S channel represents the saturation of the image, and the image information of the V channel represents the value of the image.

In general, the above input image is an RGB image, and the RGB image is first converted into an HSV spatial image, so that the image information of the H channel, the image information of the S channel, and the image information of the V channel in the HSV space of the input image can be obtained by the following formulas:

$$h = \{ \begin{matrix}0 ° & if max = min \\ 60 ° \times \frac{g - b}{max - min} + 0 ° , & if max = r and g \geq b \\ 60 ° \times \frac{g - b}{max - min} + 360 ° , & if max = r and g < b \\ 60 ° \times \frac{b - r}{max - min} + 120 ° , & if max = g \\ 60 ° \times \frac{r - g}{max - min} + 240 ° , & if max = b\end{matrix} \\ s = \{ \begin{matrix}0 & if max = 0 \\ \frac{max - min}{max} = 1 - \frac{min}{max} , & otherwise\end{matrix} \\ v = max$$

Wherein, h, s, and v represent the image information of the H channel, the image information of the S channel, and the image information of the V channel in the HSV space, respectively. r, g, and b respectively represent image information of the R channel, image information of the G channel, and image information of the B channel of the RBG space. Max is equal to the largest of r, g, and b, and min is equal to the smallest of r, g, and b.

Certainly, the embodiments of the present disclosure do not limit the input image to an RGB image. For example, the input image is an HSV image, so that the image information of the H channel, the image information of the S channel, and the image information of the V channel in the HSV space of the input image can be directly obtained.

In this embodiment, the image information of the HSV space can be obtained in the image enhancement process, and the HSV space can express the brightness, the hue, and the vividness of the color very conveniently, facilitate the contrast between the colors, facilitate conveyance of the feelings, and be a color space based on the user. In this embodiment, since the image information of the H channel represents the hue of the image, the image information of the S channel represents the saturation of the image, and the hue and the saturation correspond to the color of the image, so that in order to ensure that the color of the image does not change, only the image information of the V channel is enhanced. That is to say, only the value of the image is enhanced without changing the image information of the H channel and the image information of the S channel, thereby improving the image quality.

It should be noted that the image enhancement method based on Retinex theory provided by the embodiments of the present disclosure can be applied to any apparatus capable of enhancing an image, which, for example, includes but not limited to mobile phones, cameras, camcorders, computers, servers, etc., and there is no limit to this. The fields of application include but are not limited to video, image processing, public security criminal investigation, biomedical science and animation games.

In the embodiments, an input image is obtained, an incident component of the input image that minimizes a loss function is solved, and an optimized image of the input image based on the incident component is obtained. The loss function comprises an activation function. As such, the image quality is improved.

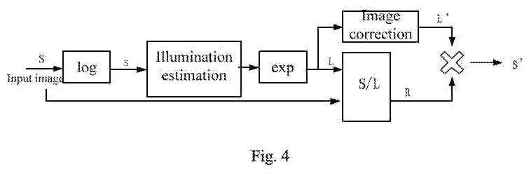

An example of an image enhancement method based on Retinex theory provided by an embodiment of the present disclosure is described below with reference to FIG. 4.

As shown in FIG. 4, the method includes acquiring an input image S, performing logarithmic domain conversion on the input image S, obtaining a logarithm s of the input image S, and then performing illumination estimation. The above illumination estimation can be understood as solving the logarithm of the incident component provided by the above embodiment, and then performing exp (exponential solution) to obtain the incident component L. In this way, the reflected component R of the input image can be obtained by Retinex theory (R=S/L), and after L is obtained, image correction (for example, gamma correction) can be performed on L to obtain a corrected component L′. Finally, the final optimized image S′ is obtained through S′=L′×R.

The image enhancement scheme shown in FIG. 4 can achieve high computational efficiency, less memory loss, better preservation of image color, and easy engineering realization and other beneficial effects.

The traditional image enhancement method uses the traditional convex optimization algorithm to solve the objective function, which is computationally complex and has a long processing time for a single picture. Moreover, it chooses to use Laplace operator to solve the image derivative. This operator is a second-order differential operator. Although this operator can extract the edge of the image, it is prone to zero gradient in back propagation, and it is not easy to estimate the smoothness of illumination. Some embodiments of the present invention replace the Laplace differential operator with a first-order differential Scharr operator, avoids the zero gradient in backpropagation, and is beneficial to the spatial smoothing of the incident component. The Adam optimization algorithm improves the computational efficiency of the algorithm and reduces the memory loss.

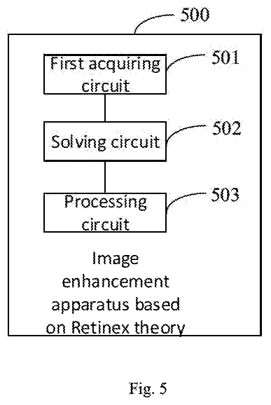

FIG. 5 is a structural diagram of an image enhancement apparatus based on Retinex theory according to one embodiment of the present disclosure. As shown in FIG. 5, the image enhancement apparatus 500 based on Retinex theory includes: a first acquiring circuit 501, configured to acquire an input image; a solving circuit 502, configured to obtain an incident component of the input image by solving a minimum value of the loss function; and a processing circuit 503, configured to obtain an optimized image of the input image based on the incident component. Wherein, the loss function comprises an activation function.

Optionally, the loss function is a function as follows:

F=c₁∥∇l∥₂²+c₂∥l−s∥₂²+c₃∥∇(s−l)∥ₗ+Relu(s−l)

Wherein, c₁, c₂ and c₃ are preset weight values, l is the logarithm of the incident component, s is the logarithm of the input image, ∇l is the first order partial derivative of l, ∇(s−l) is the first order partial derivative of s−l.

Optionally, the loss function is a function as follows:

F=c₁∥e^{l}∇l∥₂²+c₂∥l−s∥₂²+c₃∥e^{(s-l)}∇(s−l)∥ₗ+Relu(s−l)

Optionally, the Scharr operator is used to solve ∇l and ∇(s−l).

Optionally, the solving circuit 502 is configured to solve the minimum of the loss function using an Adam optimization algorithm to obtain an incident component of the input image.

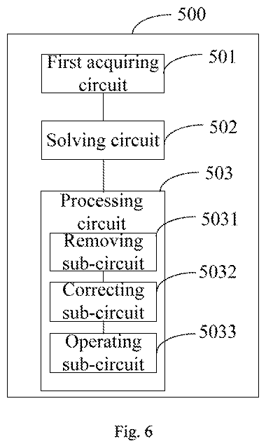

Optionally, as shown in FIG. 6, the processing circuit 503 includes a removing sub-circuit 5031, configured to remove the incident component in the input image to obtain a reflected component of the input image; a correcting sub-circuit 5032, configured to perform gamma correction on the incident component to obtain a corrected component; and an operating sub-circuit 5033, configured to obtain a product of the reflected component and the corrected component as the optimized image.

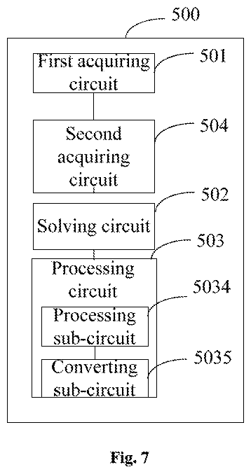

Optionally, as shown in FIG. 7, the apparatus further includes a second acquiring circuit 504, configured to acquire image information of an H channel, image information of the S channel, and image information of the V channel in the HSV space of the input image, wherein the incident component is an incident component of image information of the V channel.

The processing circuit 503 includes a processing sub-circuit 5034, configured to obtain, based on the incident component, image information of the optimized V channel of the input image; a converting sub-circuit 5035, configured to convert image information of the H channel, image information of the S channel, and image information of the optimized V channel into the optimized image of a red, green, and blue RGB space.

It should be noted that the image enhancement apparatus 500 based on the Retinex theory in the embodiment may implement any embodiment of the image enhancement method based on the Retinex theory in the embodiment of the present disclosure. That is to say, any of the embodiments of the image enhancement method based on the Retinex theory in the embodiment of the present disclosure can be implemented by the above-described Retinex theory-based image enhancement apparatus 500 in the embodiment, and achieve the same beneficial effects.

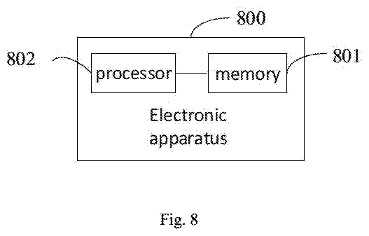

FIG. 8 is a structural diagram of an electronic apparatus according to one embodiment of the present disclosure. As shown in FIG. 8, the electronic apparatus 800 includes: a memory 801, a processor 802, and a computer program stored on the memory 801 and executable on the processor 802. The processor 802 is configured to read the computer program in the memory 801 and perform the following process: obtaining an input image; solving an incident component of the input image that minimizes a loss function; obtaining an optimized image of the input image based on the incident component. Wherein, the loss function comprises an activation function.

Optionally, the loss function is a function as follows:

F=c₁∥∇l∥₂²+c₂∥l−s∥₂²+c₃∥∇(s−l)∥ₗ+Relu(s−l)

Wherein, c₁, c₂ and c₃ am preset weight values, l is the logarithm of the incident component, s is the logarithm of the input image, ∇l is the first order partial derivative of, ∇(s−l) is the first order partial derivative of s−l.

Optionally, the loss function is a function as follows:

F=c₁∥e^{l}∇l∥₂²+c₂∥l−s∥₂²+c₃∥e^{(s-l)}∇(s−l)∥ₗ+Relu(s−l)

Optionally, the Scharr operator is used to solve ∇l and ∇(s−l).

Optionally, solving an incident component of the input image that minimizes a loss function by the processor 802 includes solving the minimum of the loss function using an Adam optimization algorithm to obtain the incident component of the input image.

Optionally, obtaining an optimized image of the input image based on the incident component by the processor 802 includes removing the incident component in the input image to obtain a reflected component of the input image; performing gamma correction on the incident component to obtain a corrected component; and using the product of the reflected component and the corrected component as the optimized image.

Optionally, before the obtaining an optimized image of the input image based on the incident component, the processor 802 is further configured to obtain image information of an H channel, image information of the S channel, and image information of the V channel in the hue, saturation value HSV space of the input image, wherein the incident component is an incident component of image information of the V channel.

Obtaining an optimized image of the input image based on the incident component by the processor 802 includes obtaining image information of the optimized V channel of the input image based on the incident component and converting the image information of the H channel, the image information of the S channel, and the image information of the optimized V channel into the optimized image of the red, green and blue RGB space,

It should be noted that, in the embodiments, the foregoing electronic apparatus can implement any embodiment in the embodiment of the image enhancement method based on the Retinex theory in the embodiment of the present disclosure. That is to say, any of the embodiments of the image enhancement method based on the Retinex theory in the embodiment of the present disclosure can be implemented by the above-mentioned electronic apparatus 800, and achieve the same beneficial effects. Examples of electronic apparatus may include, but are not limited to, mobile devices, personal digital assistants, mobile computing devices, smart phones, personal computers (PCs), desktop computers, notebook computers, servers, server arrays or server farms, network servers, distributed computing systems, cloud computing systems, or a combination thereof.

The embodiment of the present disclosure further provides a computer readable storage medium, where the computer readable storage medium stores a computer program, and when the computer program is executed by the processor, the image enhancement method based on the Retinex theory provided by the embodiment of the present disclosure is implemented. The steps in the image enhancement method based on the Retinex theory provided by the embodiments of the present disclosure are performed when the computer program is executed by the processor. The computer readable storage medium can be implemented in any type of volatile or non-volatile memory device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, disk or optical disk. The processor can be a central processing unit (CPU) or a field programmable logic army (FPGA) or a microcontroller (MCU) or a digital signal processor (DSP) or a programmable logic device (PLD) or an application specific integrated circuit (ASIC) having data processing capabilities and/or program execution capabilities.

The principles and the embodiments of the present disclosure are set forth in the specification. The description of the embodiments of the present disclosure is only used to help understand the apparatus and method of the present disclosure and the core idea thereof. Meanwhile, for a person of ordinary skill in the art, the disclosure relates to the scope of the disclosure, and the technical scheme is not limited to the specific combination of the technical features, but also covers other technical schemes which are formed by combining the technical features or the equivalent features of the technical features without departing from the inventive concept. For example, a technical scheme may be obtained by replacing the features described above as disclosed in this disclosure (but not limited to) with similar features.

What is claimed is:

1. An image enhancement method, comprising:
acquiring an input image;
solving an incident component of the input image that minimizes a loss function; and
obtaining an optimized image of the input image based on the incident component,
wherein the loss function comprises an activation function.

2. The image enhancement method of claim 1, wherein the loss function is the following function:
F=c₁∥∇l∥₂²+c₂∥l−s∥₂²+c₃∥∇(s−l)∥ₗ+Relu(s−l)
wherein, c₁, c₂ and c₃ are preset weight values, l is a logarithm of the incident component, s is a logarithm of the input image, and ∇l is the first-order partial derivative of l, ∇(s−l) is the first-order partial derivative of s−l.

3. The image enhancement method of claim 1, wherein the loss function is the following function:
F=c₁∥e^{l}∇l∥₂²+c₂∥l−s∥₂²+c₃∥e^{(s-l)}∇(s−l)∥ₗ+Relu(s−l)
wherein, c₁, c₂ and c₃ are preset weight values, l is a logarithm of the incident component, s is a logarithm of the input image, and ∇l is the first-order partial derivative of l, ∇(s−l) is the first-order partial derivative of s−l.

4. The image enhancement method of claim 2, wherein ∇l and ∇(s−l) ae solved with Scharr operator.

5. The image enhancement method of claim 1, wherein solving the incident component of the input image that minimizes the loss function comprises solving the incident component of the input image that minimizes the loss function using an Adam optimization algorithm.

6. The image enhancement method of claim 1, wherein obtaining the optimized image of the input image based on the incident component comprises:
removing the incident component in the input image to obtain a reflected component of the input image;
performing gamma correction on the incident component to obtain a corrected component; and
obtaining a product of the reflected component and the corrected component as the optimized image.

7. The image enhancement method of claim 1, before obtaining the optimized image of the input image based on the incident component, further comprises:
acquiring image information of a H channel, image information of a S channel, image information of a V channel in a hue, saturation value HSV space of the input image, the incident component being an incident component of the image information of the V channel.

8. The image enhancement method of claim 7, wherein obtaining the optimized image of the input image based on the incident component comprises:
obtaining image information of an optimized V channel of the input image based on the incident component; and
converting the image information of the H channel, the image information of the S channel, and the image information of the optimized V channel into the optimized image of the red, green and blue RGB space.

9. An image enhancement apparatus, comprising:
a first acquiring circuit, configured to acquire an input image;
a solving circuit, configured to solve an incident component of the input image that minimizes a loss function;
a processing circuit, configured to obtain an optimized image of the input image based on the incident component,
wherein the loss function comprises an activation function.

10. The image enhancement apparatus of claim 9, wherein the loss function is the following function:
F=c₁∥∇l∥₂²+c₂∥l−s∥₂²+c₃∥∇(s−l)∥ₗ+Relu(s−l)
wherein, c₁, c₂ and c₃ are preset weight values, l is a logarithm of the incident component, s is a logarithm of the input image, and ∇l is the first-order partial derivative of l, ∇(s−l) is the first-order partial derivative of s−l.

11. The image enhancement apparatus of claim 9, wherein the loss function is the following function:
F=c₁∥e^{l}∇l∥₂²+c₂∥l−s∥₂²+c₃∥e^{(s-l)}∇(s−l)∥ₗ+Relu(s−l)
wherein, c₁, c₂ and c₃ am preset weight values, l is a logarithm of the incident component, s is a logarithm of the input image, and ∇l is the first-order partial derivative of l, ∇(s−l) is the first-order partial derivative of s−l.

12. The image enhancement apparatus of claim 10, wherein ∇l and ∇(s−l) are solved with Scharr operator.

13. The image enhancement apparatus of claim 9, wherein the solving circuit is configured to solve the incident component of the input image that minimizes the loss function using an Adam optimization algorithm.

14. The image enhancement apparatus of claim 9, wherein the processing circuit comprises:
a removing sub-circuit, configured to remove the incident component in the input image to obtain a reflected component of the input image;
a correcting sub-circuit, configured to perform gamma correction on the incident component to obtain a corrected component;
an operating sub-circuit, configured to obtain a product of the reflected component and the corrected component as the optimized image.

15. The image enhancement apparatus of claim 9, further comprising:
a second acquiring circuit, configured to acquire image information of an H channel, image information of the S channel, and image information of the V channel in a HSV space of the input image, wherein the incident component is an incident component of image information of the V channel.

16. The image enhancement apparatus of claim 15, wherein the processing circuit comprises:
a processing sub-circuit, configured to obtain image information of an optimized V channel of the input image based on the incident component; and
a converting sub-circuit, configured to convert the image information of the H channel, the image information of the S channel, and the image information of the optimized V channel into the optimized image of a red, green, and blue RGB space.

17. An electronic apparatus, comprising: a memory, a processor, and a computer program stored on the memory and operable on the processor, the computer program configured to be executed by the processor to implement the image enhancement method according to claim 1.

18. A computer readable storage medium, wherein the computer readable storage medium stores a computer program, the computer program configured to be executed by a processor to implement the image enhancement method according to claim 1.
